(19) United States
(12) Patent Application Publication
(10) Pub. No.: US 2020/0311634 A1
(43) Pub. Date: Oct. 1, 2020

(54) WATER SCORE BASED SITE DEVELOPMENT

(71) Applicant: SmithGroupJJR, Inc., Detroit, MI (US)

(72) Inventors: Joe Wywrot, Ann Arbor, MI (US); Neal Billetdeaux, Manchester, MI (US)

(21) Appl. No.: 16/900,373

(22) Filed: Jun. 12, 2020

Related U.S. Application Data
(62) Division of application No. 14/029,501, filed on Sep. 17, 2013, now abandoned.

(51) Int. Cl. G06Q 10/06; G06Q 50/16

(52) U.S. Cl. CPC G06Q 10/06312; G06Q 50/16

(57) ABSTRACT

An architectural design system receives input specifying plans for (i) a site having a surface area, (ii) post-development buildings, parking lots or sidewalks arranged to occupy a portion of the surface area greater than existing buildings, parking lots and sidewalks on the site, and (iii) post-development rain water management apparatus arranged to occupy a portion of the surface area and configured to at least slow the rate at which rain water drains from the site. The system further computes a water score for the site based on expected rainfall for the site and the perviousness of the site under pre-settlement, existing and post-development conditions, and outputs the water score.

### CROSS-REFERENCE TO RELATED APPLICATIONS

This application is a divisional of U.S. application Ser. No. 14/029,501 filed Sep. 17, 2013, the disclosure of which is hereby incorporated in its entirety by reference herein.

### TECHNICAL FIELD

This disclosure relates to techniques for managing the impact development has on site rain water drainage.

### BACKGROUND

Green development (also known as green construction or sustainable building) may refer to structures that are environmentally responsible and resource-efficient throughout their life-cycle: construction, operation, maintenance, renovation and demolition. Green development expands and complements the classical building design concerns of economy, utility, durability and comfort.

### SUMMARY

A site may have a surface area and include post-development buildings, parking lots or sidewalks arranged to occupy a portion of the surface area greater than existing buildings, parking lots and sidewalks of the site. The site may also include post-development rain water containers or rain water infiltration systems configured to slow a rate at which rain water drains from the site and arranged on the site such that a water score based on an expected rainfall for the site and curve numbers of the site under pre-settlement, existing and post-development conditions falls within a predetermined range.

An architectural design system may include one or more computers programmed to receive input specifying plans for a site having a surface area, post-development buildings, parking lots or sidewalks arranged to occupy a portion of the surface area greater than existing buildings, parking lots and sidewalks on the site, and post-development rain water management apparatus arranged to occupy a portion of the surface area and configured to at least slow the rate at which rain water drains from the site. The one or more computers may be further programmed to compute a water score for the site based on expected rainfall for the site and a perviousness of the site under pre-settlement, existing and post-development conditions, and output the water score.

A computer storage medium may have instructions stored thereon that, when executed by a computer, cause the computer to prompt a user to provide input specifying plans for (i) a site having a surface area, (ii) post-development buildings, parking lots or sidewalks arranged to occupy a portion of the surface area greater than existing buildings, parking lots and sidewalks on the site, and (iii) post-development rain water management apparatus arranged to occupy a portion of the surface area and configured to at least slow the rate at which rain water drains from the site. The instructions, when executed by the computer, may further cause the computer to compute a water score for the site based on expected rainfall for the site and a perviousness of the site under pre-settlement, existing and post-development conditions, and output the water score.

### BRIEF DESCRIPTION OF THE DRAWINGS

FIG. 1 is a plot of the relationship between rainfall, curve number and runoff.

FIGS. 2a, 3a and 4a are block diagrams of pre-settlement, existing and post-development site conditions.

FIGS. 2b, 3b and 4b are schematic diagrams, in simplified cover type notation, of the site conditions of FIGS. 2a, 3a and 4a respectively.

FIG. 5 is a table summarizing the cover type information of FIGS. 2b, 3b and 4b along with corresponding curve numbers.

FIG. 6 is a table listing curve numbers by cover type and hydrologic soil group.

FIGS. 7a, 7b and 7c list monthly average rainfall and resulting average runoff values for the pre-settlement, existing and post-development site conditions of FIGS. 2b, 3b and 4b respectively.

FIG. 8 is a table of average runoff by rainfall and curve number.

FIG. 9 is a bar chart of average runoff and water score for the pre-settlement, existing and post-development site conditions of FIGS. 2b, 3b and 4b respectively.

FIG. 10 is a flow chart of an algorithm for determining a site water score.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Rain water runoff from a developed site can affect the ecological environment of the site and its surroundings. Additional development such as buildings, parking lots, sidewalks, etc. can increase the amount of site surface area occupied by impervious surfaces and therefore exacerbate issues with storm water runoff. That is as the site footprint of buildings, parking lots, sidewalks, etc. increases, the rate at which rain water drains from the site typically increases.

It has been discovered that the impact current development has had and proposed development will have on site rain water runoff can be quantified and compared by way of a water score. And that rain water management apparatus such as rain water containers, rain water infiltration systems, pervious pavement, etc. can be arranged to improve a site's water score even though the amount of site surface area occupied by impervious surfaces may be increasing. In certain examples, expected rain water runoff is calculated for pre-settlement, existing and post-development site conditions. The rain water runoff may be based on the expected rainfall for the site and the site's curve number (CN) (discussed in greater detail below) for each condition.

Pre-settlement conditions reflect the state of the site prior to any development activities (e.g., the state of the site prior to the arrival of Columbus in the Americas). Existing conditions reflect the state of the site prior to the proposed development (e.g., the state of the site as it is, the state of the site before further proposed development is carried out). Post-development site conditions reflect the state of the site as if the proposed further development has been completed.

Developing site water scores may include estimating water runoff. Techniques for estimating water runoff based on site conditions (e.g., soil, vegetation, topography, impervious surface, etc.) are known. The Technical Release 55 (TR-55) simplified procedures (“procedures”) is an example of such a technique. The United States Department of Agriculture Natural Resources Conservation Service Conservation Engineering Division Technical Release 55 “Urban Hydrology for Small Watersheds,” June 1986 details the procedures. In summary, the procedures present simplified methods to calculate rain runoff volume, peak rate of discharge, hydrographs and storage volumes required for floodwater reservoirs.

Although the SCS runoff curve number method detailed by TR-55 is well known, a brief discussion of it is included herein for reference. The SCS runoff equation is

Q=(P−Ia)²/{(P−Ia)+S} (1)

where, Q=runoff (inches), P=rainfall (inches), S=potential maximum retention after runoff begins (inches), and Iₐ=initial abstraction (inches). Iₐ represents all losses before runoff begins: it includes water retained in surface depressions, water intercepted by vegetation, infiltration, etc. Iₐ can be approximated by the following empirical equation:

Iₐ=0.2S (2)

Substituting (2) into (1) yields

Q=(P−0.2S)²/(P+0.8S) (3)

S is related to soil and cover conditions through CN, which has a range between 0 and 100, according to the following equation:

S={1000/CN}−10 (4)

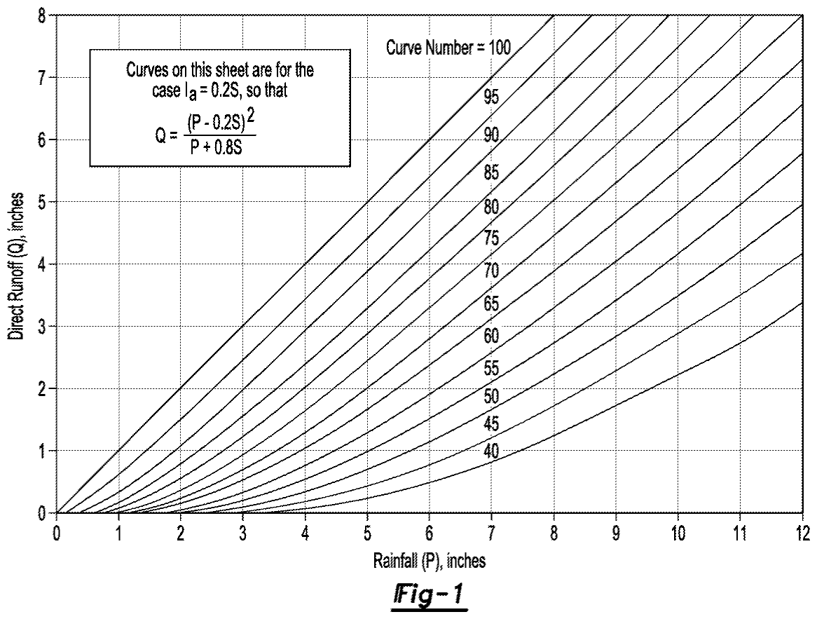

Substituting (4) into (3), FIG. 1 graphically illustrates the relationship between P, Q and CN. Therefore if P and CN are known, Q can be determined.

TR-55 provides tables that list CN values according to cover type (e.g., vegetation, bare soil and impervious surface), hydrologic condition (e.g., effect of cover type and treatment on infiltration and runoff), average percent impervious area, hydrologic soil group as well as other factors. There are a number of methods for determining cover type including field reconnaissance, aerial photographs and land use maps. Hydrologic condition can be estimated from plant density and residue cover of sample areas. A good hydrologic condition indicates that the soil has a low runoff potential given the cover type, soil group, etc. Factors that may be considered in estimating hydrologic condition include vegetative density, seasonal coverage, lawn area and degree of surface roughness.

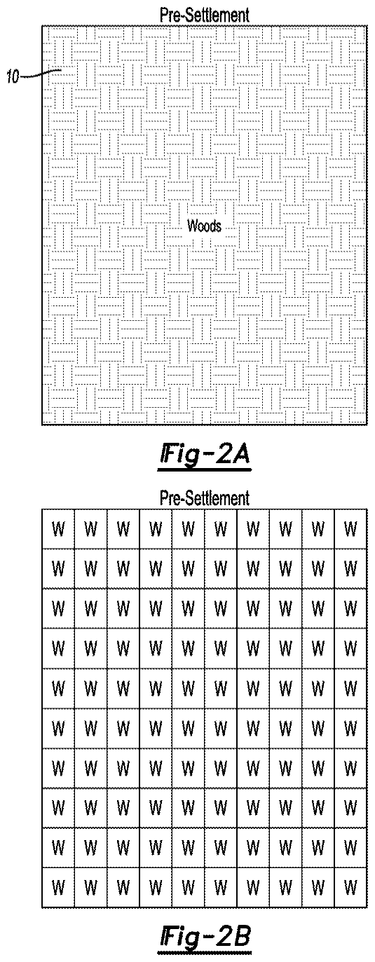

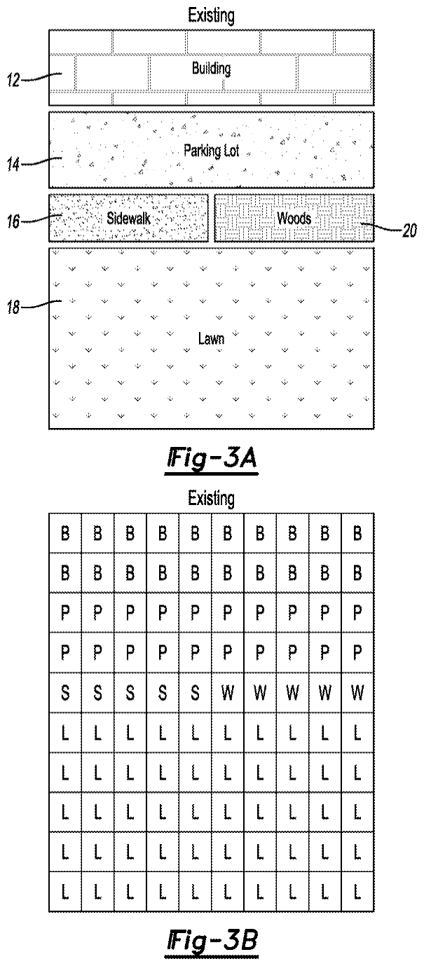

Referring to FIGS. 2a, 3a and 4a, an example site is shown under pre-settlement, existing and post-development conditions. Pre-settlement conditions, as mentioned above, can be determined from land use maps, etc. In this example, the pre-settlement site is completely covered by woods 10. The existing site includes buildings 12, a parking lot 14, a sidewalk 16, a lawn 18 and woods 20. The relative size and shape of the boxes represent the approximate surface area occupied. Again, maps or field reconnaissance can be used to determine existing conditions. The post-development site includes buildings 22, a parking lot 24, a sidewalk 26, a lawn 28 and woods 30 as well as water management apparatus. Notably, the buildings 22, parking lot 24 and sidewalk 26 occupy a greater portion of the site than under existing conditions. In this example, the water management apparatus include water containers 32 (located on top of the buildings 22), pervious pavement 34 (which is part of the parking lot 24) over a water infiltration system 36 (that is, the water infiltration system 36 is underneath the pervious pavement 34), and a pervious sidewalk 38 (which is part of the sidewalk 26). Of course, other suitable water management apparatus (e.g., bioswales, vegetative roof coverings, etc.) may be used.

As known in the art, water containers can be any type of reservoir that captures and stores rain water or slows the rate of rain water runoff; water infiltration systems are in-ground arrangements of particular soils, gravel, etc. arranged to have voids and that slow the rate at which rain water drains from the system; and pervious pavements or sidewalks, for example, are black top or concrete like materials that allow increased amounts of rain water to drain through them as compared with impervious surfaces.

Referring to FIGS. 2b, 3b and 4b, the site of FIGS. 2a, 3a and 4a has been divided into a 10 by 10 grid with each cell representing a 1 acre plot of land. Table 1 provides a legend for the notation used in FIGS. 3a through 3c.

TABLE 1

| Building | Building | Parking Lot | Parking Lot | Misc. Paved | Misc. Paved | | |
|---|---|---|---|---|---|---|---|
| (Traditional) | (Green) | (Traditional) | (Green) | (Traditional) | (Green) | Lawn | Woods |
| B | b | P | p | S | s | L | W |

That is, the letter “B” (capital and lower case) is used to represent 1 acre of land occupied by buildings, the letter “P” (capital and lower case) is used to represent 1 acre of land occupied by parking lots, the letter “S” (capital and lower case) is used to represent 1 acre of land occupied by miscellaneous pavement (e.g., sidewalks), the letter “L” represents 1 acre of land occupied by lawn, and the letter “W” represents 1 acre of land occupied by woods. Lower case letters indicate that those portions of the site have been constructed to include water management apparatus. In this example, the water containers 32 cover 8 acres of the buildings 22, the pervious pavement 34 and underlying infiltration system 36 comprise 8 acres of the parking lot 24, and the pervious sidewalk 38 comprises 3 acres of the sidewalk 26.

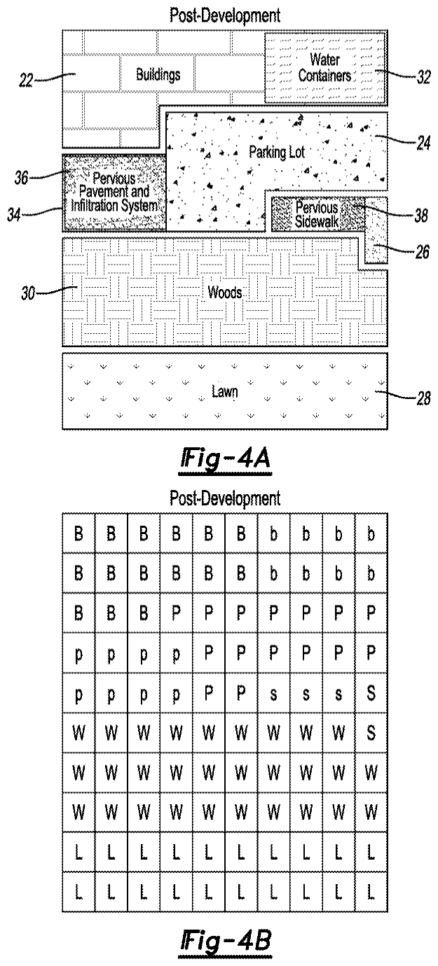

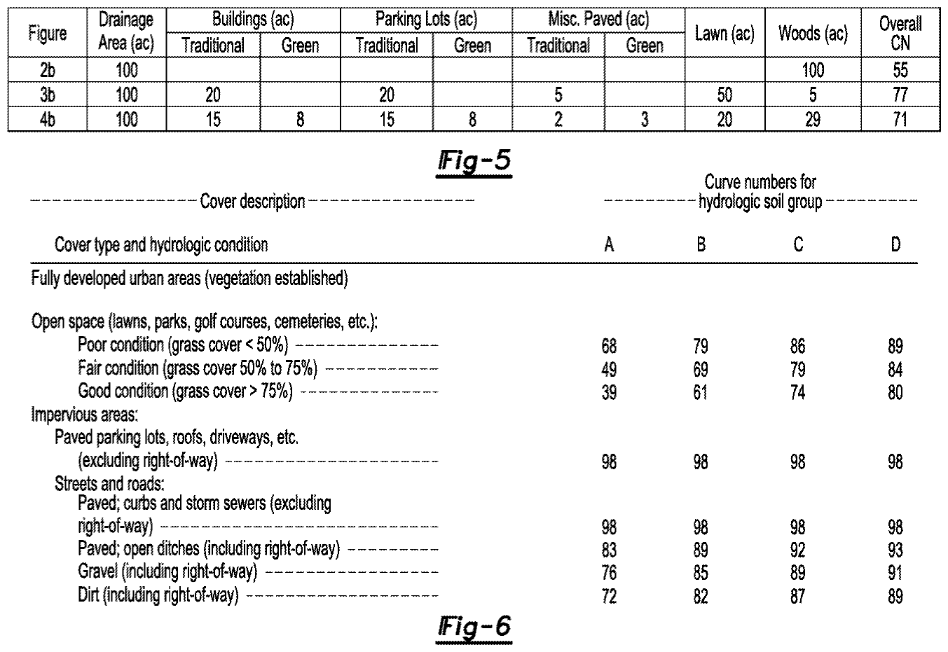

The cover type notation used to characterize the site surface under the pre-settlement, existing and post-development conditions is summarized in the table of FIG. 5. This information along with site hydrologic soil group, etc. at each of the conditions can then be used to derive corresponding CNs using the TR-55 tables mentioned above. FIG. 6 provides an example of such a table. That is for a given cover type and hydrologic soil group, a corresponding CN can be identified. FIG. 6 lists but a few of the many identified cover types and other data in the TR-55 tables.

Referring again to FIG. 5, a CN, for example, can be determined for the buildings 12, parking lot 14, etc. and a weighted average of these CNs can be computed to generate an overall CN for the existing site. A similar process can be followed to generate overall CNs for the pre-settlement and post-development sites. Assuming for example that the CN associated with woods for a given hydrologic soil group present at the pre-settlement site is 55, the overall CN for the pre-settlement site would be 55 because woods cover 100% of the site. Assuming that the CN associated with buildings is “V,” the CN associated with parking lots is “X,” the CN associated with sidewalks is “Y,” and the CN associated with lawn is “Z” for a given hydrologic soil group present at the existing site, the overall CN for the existing site can be computed as follows:

Overall CN_{existing}=(0.2*V)+(0.2*X)+(0.05*Y)+(0.5*Z)+(0.05*55) (5)

Assuming that the CN associated with a building incorporating water management apparatus (or green building) is “v,” the CN associated with parking lots incorporating water management apparatus (or green parking lots) is “x,” and the CN associated with sidewalks incorporating water management apparatus is “y” for a given hydrologic soil group present at the post-development site, the overall CN for the post-development site can be computed as follows:

Overall CN_{post-development}=(0.15*V)+(0.08*v)+(0.15*X)+(0.08*x)+(0.02*Y)+(0.03*y)+(0.20*Z)+(0.29*55) (6)

FIG. 5 further summarizes the overall CNs for the examples above.

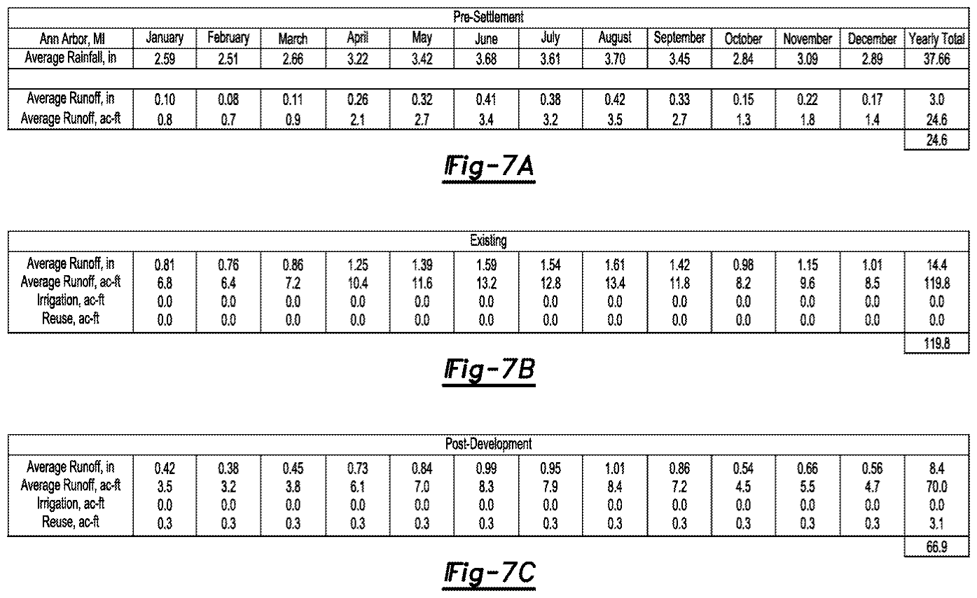

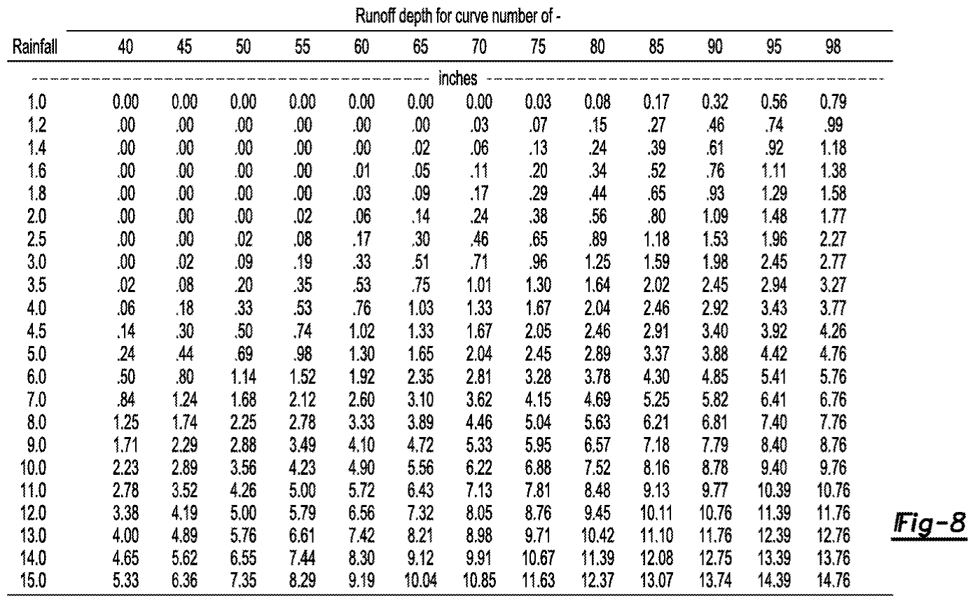

FIGS. 7a through 7c list average monthly rainfalls for a 12 month period. The resulting average runoffs associated with the average monthly rainfalls can be estimated with reference to data similar to that listed in FIG. 8 (or with equations used to generate data similar to that listed in FIG. 8). For example, 2.59 inches of rainfall is listed for January and the CN for pre-settlement conditions is 55. Referring to the column labeled “55” of FIG. 8 and interpolating between the rows labeled “2.5” and “3.0,” the resulting average runoff is 0.10 inches (or 0.8 acre-feet). 2.51 inches of rain fall is listed for February and the CN for pre-settlement conditions is 55. Referring again to the column labeled “55” of FIG. 8 and interpolating between the rows labeled “2.5” and “3.0,” the resulting average runoff is 0.08 inches (or 0.7 acre-feet), etc. (Some of the average runoff values listed in FIGS. 7a through 7c may differ somewhat from that suggested by FIG. 8 because equations were used in certain instances to calculate the average runoff as opposed to interpolation.) The total average runoff for the 12 month period can be calculated by summing the average monthly runoffs. The above process can be followed to determine existing and post-development total average runoffs.

The reuse values of FIG. 7c are associated with post-development water management apparatus. As explained above, certain water management apparatus such as water containers can capture and store rainfall. This stored water may be reused for sewer and other purposes and therefore does not impact runoff. The reuse values can be determined, for example, based on the volume associated with post-development water containers. That is in the example of FIG. 7c, the post-development water containers have a storage volume equivalent to 0.3 acre-feet. And, the monthly rainfall is sufficient to fill completely the post-development water containers.

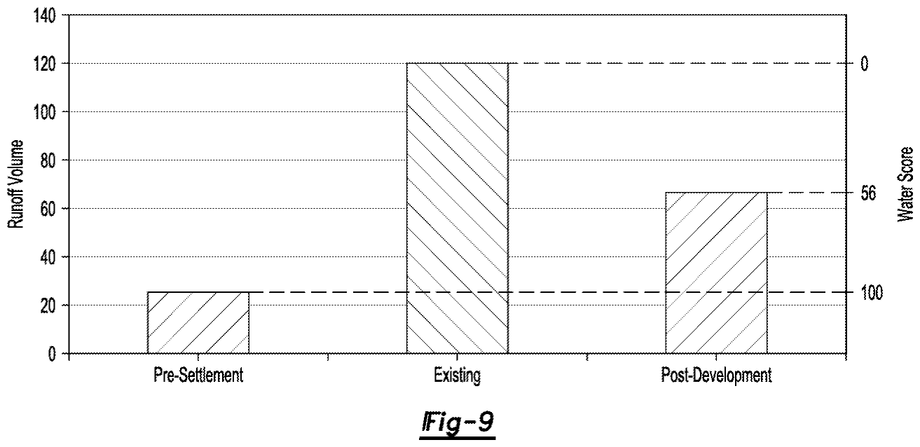

With reference to FIG. 9, the total average runoffs for the pre-settlement, existing and post-development conditions are plotted as a bar chart. To calculate the water score associated with the post-development site, the existing total average runoff was normalized to a score of 0 and the pre-settlement average runoff was normalized to a score of 100. The post-development average total runoff is then compared against the normalized scores to generate a post-development water score—in this example, 56. Because the pre-settlement runoff was normalized to 100 and the existing runoff was normalized to 0, the higher the water score the better. That is, pre-settlement runoff is deemed to be optimum. In other examples however, the pre-settlement runoff can be normalized to 100 and the existing runoff can be normalized to 0. In these examples, the lower the water score the better.

Several post-development schemes can thus be generated and compared on the basis of water score. Moreover, a particularly attractive post-development plan can be modified with water management apparatus if its water score is found to be lacking. In contrast, conventionally proposed building plans may be developed without understanding the impact such development will have on rain water runoff relative to existing and pre-settlement conditions.

Note that grids similar to those of FIGS. 2b, 3b, and 4b need not be used to determine corresponding overall CNs. Such grids were discussed for ease of reference. Any suitable technique to quantify area may be used. Moreover, techniques other than those associated with TR-55 such as testing, simulation, etc. can be used to determine CNs by cover type, etc.

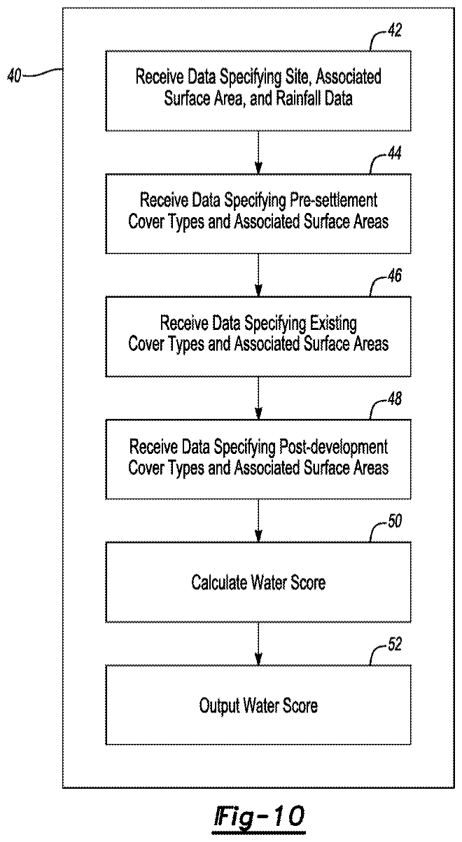

With reference to FIG. 10, one or more computers 40 may be programmed to determine water score as described above. At operation 42, data is received specifying a site, its associated surface area, and rainfall. As discussed with reference to FIGS. 2a through 4b for example, the site had a surface area of 100 acres. Furthermore, rainfall data similar to that described with reference to FIG. 7A may be received. Data is received specifying pre-settlement cover types and associated surface areas, existing cover types and associated surface areas, and post-development cover types and associated surface areas at operations 44, 46 and 48 respectively. Data, for example, similar to that discussed with reference to FIG. 5 may be received. At operation 50, water score is calculated. That is, the various overall CNs may be determined using techniques similar to those described with reference to FIGS. 5 and 6. The pre-settlement, existing and post-development total average runoffs may be determined using techniques similar to those described with reference to FIGS. 7a through 7c and 8. And, the water score may be determined using techniques similar to those described with reference to FIG. 9. The water score may then be output at operation 52. The water score, for example, may be displayed or stored, etc. Different post-development cover types and associated surface areas may be repeatedly entered to evaluate and compare the water scores associated with each.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

The words used in the specification are words of description rather than limitation, and it is understood that various changes may be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An architectural design system comprising:
one or more computers programmed to
receive input specifying plans for (i) a site having a surface area, (ii) post-development buildings, parking lots or sidewalks arranged to occupy a portion of the surface area greater than existing buildings, parking lots and sidewalks on the site, and (iii) post-development rain water management apparatus arranged to occupy a portion of the surface area and configured to at least slow the rate at which rain water drains from the site,
compute a water score for the site based on an amount of rain water runoff associated with post-development conditions that is derived from expected rainfall and curve numbers for the site under the post-development conditions and is normalized such that
one of (i) an amount of rain water runoff associated with pre-settlement conditions that is derived from expected rainfall and curve numbers for the site under the pre-settlement conditions and (ii) an amount of rain water runoff associated with existing conditions that is derived from expected rainfall and curve numbers for the site under existing conditions defines a maximum achievable water score, and
the other of the amount of rain water runoff associated with the pre-settlement conditions and the amount of rain water runoff associated with the existing conditions defines a minimum achievable water score, and
output the water score.

2. The system of claim 1, wherein the post-development rain water management apparatus include rain water containers or rain water infiltration systems.

3. A computer storage medium having instructions stored thereon that, when executed by a computer, cause the computer to
prompt a user to provide input specifying plans for (i) a site having a surface area, (ii) post-development buildings, parking lots or sidewalks arranged to occupy a portion of the surface area greater than existing buildings, parking lots and sidewalks on the site, and (iii) post-development rain water management apparatus arranged to occupy a portion of the surface area and configured to at least slow the rate at which rain water drains from the site,
compute a water score for the site based on an amount of rain water runoff associated with post-development conditions that is derived from expected rainfall and curve numbers for the site under the post-development conditions and is normalized such that
one of (i) an amount of rain water runoff associated with pre-settlement conditions that is derived from expected rainfall and curve numbers for the site under the pre-settlement conditions and (ii) an amount of rain water runoff associated with existing conditions that is derived from expected rainfall and curve numbers for the site under existing conditions defines a maximum achievable water score, and
the other of the amount of rain water runoff associated with the pre-settlement conditions and the amount of rain water runoff associated with the existing conditions defines a minimum achievable water score, and
output the water score.

4. The storage medium of claim 3, wherein the post-development rain water management apparatus include rain water containers or rain water infiltration systems.
